(19) United States
(12) Patent Application Publication
(10) Pub. No.: US 2018/0105234 A1
(43) Pub. Date: Apr. 19, 2018

(54) DEPLOYABLE CONNECTION AND EMERGENCY RELEASE SYSTEM

(71) Applicant: HOULDER LIMITED, London (GB)

(72) Inventors: Frederic Vincent PERDRIX, London (GB); Gianpaolo BENEDETTI, London (GB); Luiz Eduardo DEMENICIS, London (GB)

(21) Appl. No.: 15/568,618

(22) PCT Filed: Apr. 8, 2016
(86) PCT No.: PCT/GB2016/050988

§ 371 Date: Oct. 23, 2017

(30) Foreign Application Priority Data
Apr. 24, 2015 (GB) 1506974.3

(51) Int. Cl. B63B 27/34; B63B 27/24; B67D 9/00

(52) U.S. Cl. CPC B63B 27/34; B67D 9/00; B63B 27/24

(57) ABSTRACT

There is provided a fluid transfer system (100) and method in which a transfer manifold (150) is secured to a frame (120). The frame (120) is designed to engage with a coupling point (328) in a vessel, in order to support the manifold (150) in a desired position.

### RELATED APPLICATION

The present application is a national stage application under 35 U.S.C. § 371 of International Application No. PCT/GB2016/050988, filed 8 Apr. 2016, and which claims priority from GB Patent Application No. 1506974.3, filed 24 Apr. 2015. The above-referenced applications are hereby incorporated by reference into the present application in their entirety.

### FIELD OF THE INVENTION

The present invention relates to a deployable connection and emergency release apparatus. In particular, but not exclusively, the present invention relates to a deployable connection apparatus for assisting in the connection and disconnection of hoses transferring liquids or gases such as hydrocarbon fuels, for example liquid natural gas (LNG). The present invention finds particular utility in a marine environment.

### BACKGROUND TO THE INVENTION

In many environments it is required to transfer fluid between bodies. For example, in a marine environment, fluids such as hydrocarbon fuels are often loaded onto ships. For small or medium sized vessels, the hoses and manifolds used to transfer the fluid can be small enough to be manually handled and connected. However, it can be difficult to manoeuvre the components; in particular, it can be difficult to manoeuvre the hoses or connect the manifolds in rough or otherwise difficult sea conditions. Such issues occur when a ship is supplied from the shore and also when ships are supplied by other floating vessels. For example, a bunker vessel may be used to refuel another vessel.

The transfer of fluid between two bodies occurs through fluid paths coupled to each vessel, which should be able to be connected and disconnected under a range of circumstances. In recent years, the use of liquid natural gas (LNG) as a fuel for maritime vessels has increased in popularity, meaning that the provision of a system that facilitates the safe, flexible, and controllable connection of fluid paths between bodies, such as two vessels, is increasingly desirable.

It is particularly important to prevent impacts during the connection process or during any emergency disconnection scenario when using LNG fuel as LNG is extremely volatile, meaning that any spark caused by the impact could cause an explosion. It is also important to prevent LNG fuel leaking or spilling onto a vessel, as the fuel can damage the structure of the vessel.

### SUMMARY OF THE INVENTION

According to a first aspect of the present invention there is provided a fluid transfer apparatus comprising:

a transfer manifold; and

a frame secured to the transfer manifold, wherein a base portion of the frame is configured for engagement with a first coupling point of a receiving vessel in order to support a weight of the transfer manifold.

The apparatus of the present invention can assist in providing both flexibility and improved safety and control to a fluid transfer operation. For small manifolds, the frame is sufficient to support the weight of the manifold, facilitating an improved handling and connection of the transfer manifold and reducing the risk of impacts.

Optionally, there is further provided attachment means secured to the frame at a position removed from the base portion, wherein the attachment means are configured for engagement with a second coupling point of the receiving vessel located at a position removed from the first coupling point. In particular, the use of multiple coupling points on a receiving vessel supports the weight of the transfer manifold during a fluid transfer operation facilitating an improved handling and connection of the transfer manifold.

Optionally, the attachment means comprises a cable. Optionally, the attachment means comprises a rigid arm. Either arrangement facilitates a more secure connection between the transfer manifold and a receiving vessel. The attachment means may be extensible, but once the attachment means are engaged with the second coupling point, the length of the attachment means is preferably fixed to better support the weight of the transfer manifold. Alternatively, the attachment means may be a fixed length.

Preferably, the transfer manifold is suspended from a support member. Optionally, the transfer manifold is suspended from the support member by an extensible member. This arrangement facilitates an improved control of the position of the transfer manifold within desired parameters when the manifold is being manoeuvred towards a receiving vessel prior to a fluid transfer operation.

Preferably, the transfer manifold comprises a distal part and a proximal part, the distal part being removably coupled from the proximal part, wherein the frame is fixed to the distal part. Preferably, the proximal part is suspended from the support member. When the fluid transfer apparatus comprises attachment means, the attachment means may also be fixed to the distal part of the transfer manifold. Optionally, an emergency disconnection section couples the distal part of the transfer manifold to the proximal part, wherein the emergency disconnection section is configured to decouple the distal part from the proximal part when a tension across the transfer manifold exceeds a threshold. This arrangement is advantageous as it can facilitate the cessation of fluid transfer in an emergency disconnection scenario, thereby preventing spillage of fluid fuel such as LNG.

Optionally, the distal part of the transfer manifold comprises one or more flexible hoses. Preferably, each of the one or more flexible hoses is configured for connection to a receiving manifold of the receiving vessel. The use of flexible hoses can be advantageous as it can enable the use of the transfer manifold with a range of different receiving manifolds, without requiring retrofitting of the receiving manifold to ensure the separation of fluid transfer assemblies matches the separation of the transfer manifold. Furthermore, flexible hoses are advantageous as they are easier to manoeuvre.

Preferably, support means are coupled between each of the one or more flexible hoses and the distal part of the transfer manifold, wherein the support means are extensible. Optionally, the support means comprise a winch and a cable. The support means fix the flexible hoses in a secure position during the manoeuvre and handling of the transfer manifold, thereby preventing any impacts, either between the hoses or between the hoses and the receiving vessel, which may cause a spark.

According to a second aspect of the present invention, there is provided a fluid transfer facility comprising a fluid transfer apparatus of the first aspect. The fluid transfer facility may be a bunker vessel. A bunker vessel is a vessel designed to provide fuel to another vessel. As both vessels may be moving during the fuel transfer, it is important to provide a transfer apparatus that is safe and easy to use and reduces the risk of impact or spillage; as such, the fluid transfer apparatus of the present invention finds particular utility. Alternatively, the apparatus described above may be provided on a jetty, or any other suitable fluid transfer facility.

According to a third aspect of the present invention, there is provided a fluid transfer system comprising:

a transfer manifold;

a receiving manifold for coupling to the transfer manifold to form a fluid path therewith;

a first coupling point of a receiving vessel; and

a frame secured to the transfer manifold, wherein a base portion of the frame is configured for engagement with the first coupling point in order to support a weight of the transfer manifold.

Optionally, the system may further comprise a second coupling point of a receiving vessel, the second coupling point located at a position removed from the first coupling point and attachment means secured to the frame at a position removed from the base portion, wherein the attachment means are configured for engagement with the second coupling point. This architecture can facilitate the improved connection of the transfer manifold to the receiving manifold.

The second or third aspects of the present invention may have any of the features described above with reference to the fluid transfer apparatus of the first aspect, either alone or in combination with any of the other features described above.

According to a fourth aspect, there is provided a method for carrying out fluid transfer, comprising:

suspending a transfer manifold from a support member;

manoeuvring the support member until a base portion of a frame secured to the transfer manifold engages with a first coupling point of a receiving vessel;

extending a support means coupled between the transfer manifold and a flexible hose of the transfer manifold to position the flexible hose near to a receiving manifold of the receiving vessel, the flexible hose configured for connection to the receiving manifold;

connecting the flexible hose of the transfer manifold to the receiving manifold; and

initiating a fluid transfer operation between the receiving manifold and the transfer manifold.

Optionally, the method may further comprise, prior to the step of extending the support means, securing attachment means to a second coupling point of the receiving vessel, wherein the attachment means are secured to the frame at a position removed from the base portion, and wherein the second coupling point is located at a position removed from the first coupling point.

Optionally, a tensile force is applied to the transfer manifold by an extensible member during the fluid transfer operation. Preferably, the fluid is a hydrocarbon fuel, more preferably liquid natural gas (LNG). In particular embodiments there may be provided two catenary hoses. These may carry LNG to a receiving system and receive boil off gas (i.e. LNG which has evaporated) from the receiving system.

### BRIEF DESCRIPTION OF THE DRAWINGS

Embodiments of the present invention will now be described with reference to the accompanying drawings, in which:

FIG. 1 shows a perspective view of a fluid transfer apparatus according to a preferred embodiment of the present invention;

FIG. 2 is a side view of a close up of the fluid transfer apparatus according to the preferred embodiment of the present invention;

FIG. 3 is a perspective view of the fluid transfer apparatus according to the preferred embodiment of the present invention showing the first connection point of the apparatus;

FIG. 4 is a side view of the fluid transfer apparatus according to the preferred embodiment of the present invention showing the second connection point of the apparatus; and

FIG. 5 is a side view of the fluid transfer apparatus according to the preferred embodiment of the present invention showing the connection of the manifolds.

### DETAILED DESCRIPTION

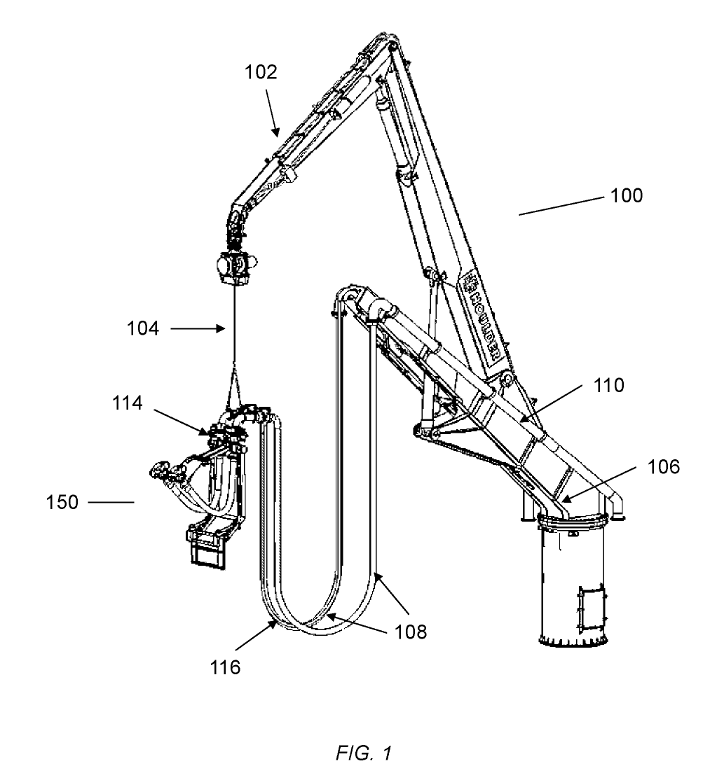

With reference to FIG. 1, a perspective view of a fluid transfer apparatus 100 is shown. The fluid transfer apparatus 100 is designed to provide fluid, particularly but not exclusively liquid natural gas (LNG), to a receiving vessel and to receive boil-off gas (LNG vapour) therefrom.

The fluid transfer apparatus comprises two catenary hoses 108 each suspended from a support member 106 at an end of the fluid transfer apparatus proximal to the refuelling vessel or the jetty. The distal end of each catenary hose 108 is coupled to a transfer manifold 150. As such, the apparatus 100 may transfer fluid to and from a receiving vessel through a path comprising the rigid pipe 110, the catenary hose 108 and the transfer manifold 150.

The apparatus 100 facilitates the easier handling of the transfer manifold 150 and connection of the transfer manifold 150 to a receiving manifold of the receiving vessel. It also allows connections to be made more safely in difficult sea conditions by reducing the risk of impacts which could cause the LNG to ignite.

The transfer manifold 150 is suspended from the support arm 102. The support arm 102 comprises a plurality of rigid elements which are movable relative to one another and are hydraulically controlled. The movable elements are pivotally mounted to each other. In the preferred embodiment, the pivotal mounting of the rigid elements is around a horizontal axis, although other axes or forms of movement are possible. By controlling the position of the support member 102, the position of the transfer manifold 150 can therefore be controlled.

The transfer manifold 150 is suspended from the support arm 102 by a member 104. In the preferred embodiment, the member 104 is extensible in the sense that its longitudinal extent may vary. The member 104 is a wire element, for example a cable. The length of the member 104 is adjustable, for example through the use of a winch. The combination of the movement of the support arm 102 and the extension or contraction of the member 104 allows the horizontal and vertical positioning of the transfer manifold 150 to be adjusted. This allows the manifold 150 to be manoeuvred into a position at a receiving vessel such that the manifold 150 may be easily secured to the receiving vessel. The transfer manifold 150 can then be safely connected to the receiving manifold. The securing and connecting of the transfer manifold 150 may be manual or it may be automatic. In some embodiments, the member 104 may be a fixed length rather than extensible.

In some embodiments, the member 104 may be maintained at a constant tension during the entire connection and fluid transfer operation. For example, the member 104 may be a tensioning member which is maintained under constant tension by a tension drive element such as a constant tension winch which releases more or less wire according to the current level of tension. However, for small and medium size vessels the manifold 150 may be small enough and/or light enough that it can be manually manoeuvred and connected. It may therefore not be necessary to maintain the member 104 at a constant tension.

The transfer manifold 150 comprises two separate fluid path assemblies. The two fluid paths of the transfer manifold 150 can be connected to corresponding fluid transfer paths on a receiving vessel. The two fluid paths are used to connect two different catenary hoses. When transferring liquid natural gas (LNG), it is often necessary not only to transfer the LNG to the receiving vessel, but also to carry boil off gas (LNG vapour) away from that vessel. Therefore, there may be a need to connect a vapour line in addition to the catenary hose carrying the LNG. Each fluid path assembly comprises a distal part and a proximal part connected by an emergency disconnection system 114.

The emergency disconnection system 114 is hydraulically powered via a hydraulic supply line 116, which is suspended from the support member 106. The emergency disconnection system comprises a double isolation valve, particularly a double ball valve for each fluid path which is activated to prevent transfer of fluid through each fluid path assembly in the case of an emergency.

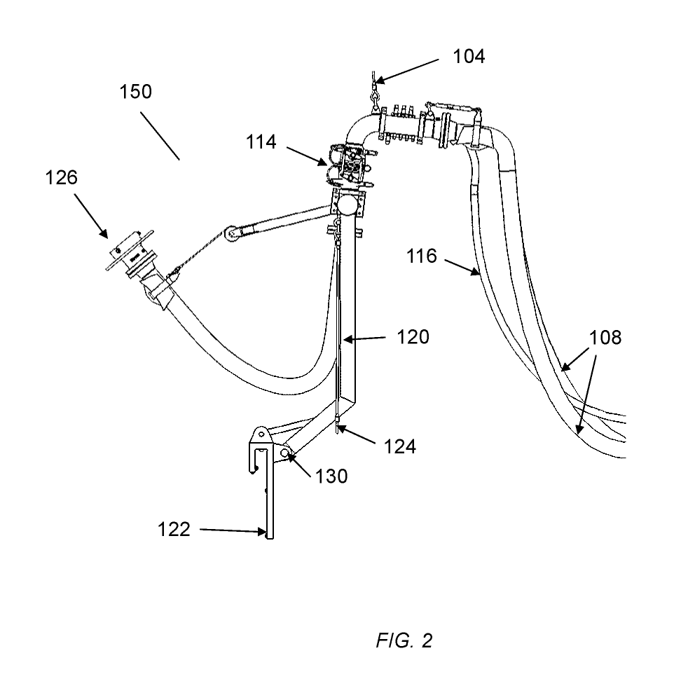

With reference to FIG. 2, a close up of the fluid transfer apparatus is shown. In particular, the transfer manifold 150 and surrounding components are shown. The emergency disconnection system 114 may separate the transfer manifold 150 into a distal part and a proximal part. Preferably, the proximal part is coupled to the catenary hoses 108. Preferably, the proximal part of the transfer manifold is also coupled to the member 104. Alternatively, the emergency disconnection system 114 may not physically separate the proximal and distal parts of the transfer manifold 150, but may prevent the flow of fluid between the two parts in an emergency disconnection scenario.

A frame 120 is secured to the distal part of the transfer manifold 150. In the preferred embodiment, the frame 120 is a rigid frame. The frame 120 comprises a base portion 122, which may be rigidly coupled to the frame 120. Alternatively, it may be movably coupled. For example, the base portion 122 may be rotatably coupled to the frame 120 such that the base portion 122 is able to rotate around a fixed point, for example a pivot point 130. In other embodiments, the base portion 122 may be coupled to the frame 120 such that the base portion 122 is able to move laterally or longitudinally with respect to the frame 120. In other embodiments, the base portion 122 may be rigidly coupled to the frame 120 such that the base portion 122 is fully integrated into the rigid frame 120; for example, the frame 120 and the base portion 122 may comprise a single component.

The fluid transfer apparatus 100 of this preferred embodiment also comprises attachment means 124. The attachment means are secured to the frame 120 at a position removed from the base portion 122. In some embodiments, the attachment means 124 may be directly secured to the transfer manifold 150 and not the frame 120. In some embodiments, the attachment means 124 are flexible but in other embodiments the attachment means 124 may be rigid. For example, the attachment means may be a flexible wire or a flexible cable, or may be a rigid arm such as a metal arm, or an arm formed of any other suitable material. The attachment means 124 of the preferred embodiment are extensible. The longitudinal extent of the attachment means 124 can be varied by adjusting a bottle screw at one end of the attachment means. In other embodiments, the length of the attachment means can be adjusted by, for example, a winch or another form of screw. When the attachment means are extensible, they should comprise a mechanism suitable for fixing the length of the attachment. Therefore, the length of the attachment means can be adjusted to be an appropriate length for use with a range of manifolds. The length of the attachment means can be fixed when the attachment means are in use in order to facilitate an improved connection and support of the transfer manifold. Alternatively, the attachment means can be of a fixed length. In other embodiments, the fluid transfer apparatus 100 may not comprise attachment means.

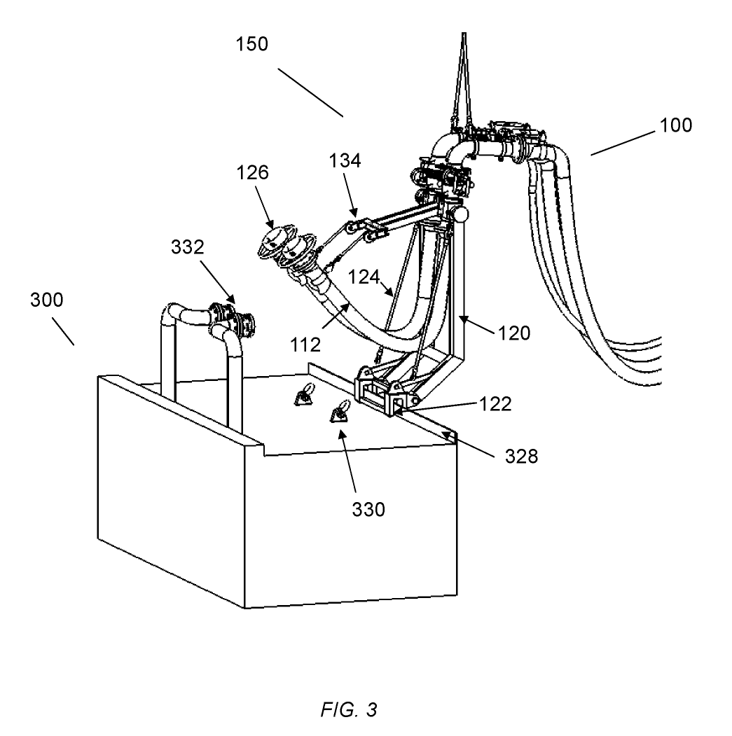

With reference to FIG. 3, a perspective view of part of the fluid transfer apparatus 100 and a section of a receiving vessel 300 is shown. The transfer manifold 150 comprises flexible hoses 112 which can be manoeuvred into position to connect to a receiving manifold 332 on the receiving vessel 300. The flexible hose 112 is configured for connection to the receiving manifold via connection means 126. The connection means 126 may be any suitable type of connection for use in the transfer of liquid fuel.

Prior to a fluid transfer operation, the apparatus 100 is manoeuvred into a position proximate to the receiving vessel 300 by the support arm 102 in order to allow for securing of the transfer manifold 150 to the receiving vessel 300 and a subsequent connection to the receiving manifold 332. The base portion 122 of the frame 120 is configured for engagement with a first coupling point 328 of the receiving vessel 300. The engagement of the base portion 122 and the first coupling point 328 allows the weight of the transfer manifold 150 to be supported whilst the flexible hose or hoses are moved into position for coupling to a manifold on the receiving vessel. This arrangement enables operators to connect the transfer manifold to the receiving manifold more easily and more safely. In the preferred embodiment, the first coupling point 328 is a side of the receiving vessel 300. In particular, the first coupling point 328 is located in the side of the receiving vessel 300 at a gun port. In other embodiments, the first coupling point 328 may be a lip or ridge on the receiving vessel 300 designed to receive or support the base portion 122.

The shape of the base portion 122 is designed such that the base portion 122 can be hooked or latched over the side of the receiving vessel 300 at the first coupling point 328. For example, the base portion of the preferred embodiment is substantially U-shaped. In other embodiments, the base portion 122 may be L-shaped, or any other shape suitable for engagement with the first coupling point 328. In the preferred embodiment, the base portion 122 is rotatably coupled to the rigid frame 120 around the pivot point 130 shown in FIG. 2 in order to facilitate an improved contact with the receiving vessel 300, as the side of the receiving vessel may not always be suitably aligned for the orientation of the frame 120. Therefore, by allowing the base portion 122 to rotate relative to the frame 120, a secure engagement may be made between the base portion 122 and the first coupling point 328 for all geometries of receiving vessel. The flexibility between the base portion 122 and the frame 120 also allows some of the shock of the landing of the fluid transfer manifold 150 to be absorbed. In some embodiments, rubber or another substantially elastic substance may be incorporated into the base portion in order to further absorb the shock of the landing on the side of the receiving vessel 300. In other embodiments, as described above, the base portion 122 may be rigidly coupled to the frame 120 and any shock or reverberations generated during the landing on the receiving vessel may be absorbed by the frame.

In embodiments where the first coupling point 328 is a lip or ridge, rather than a side, of the receiving vessel 300, the base portion 122 is configured to hook or latch over the lip or ridge in order to support the weight of the transfer manifold 150. In other embodiments, the base portion 122 may be coupled to the receiving vessel 300 by means of a screw or bolt or other connection means suitable for supporting the weight of the transfer manifold 150. In some embodiments, whether the base portion 122 is rotatably or otherwise moveably coupled to the frame 120, or is rigidly coupled to the frame 120, a further connection between the fluid transfer apparatus and the receiving vessel is made with the attachment means 124 to ensure that the weight of the transfer manifold 150 is securely and fully supported. In other embodiments in which the fluid transfer apparatus does not comprise attachment means, the weight of the transfer manifold is fully supported by the engagement of the base portion with the first coupling point of the receiving vessel. This has particular application for small and medium sized vessels in which the manifold and hoses can be manually handled.

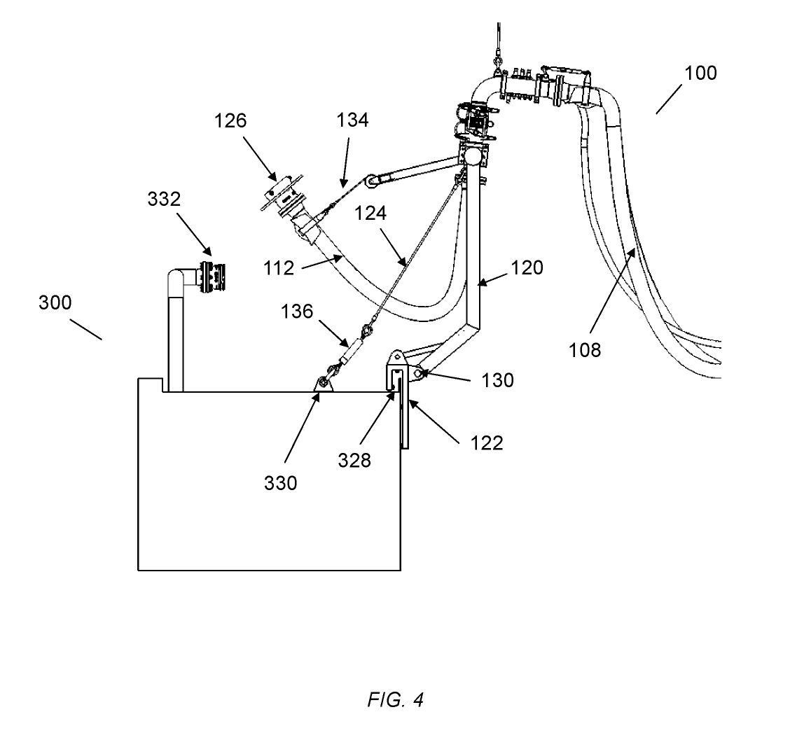

With reference to FIG. 4, a side view of the fluid transfer apparatus 100 and receiving vessel 300 is shown. The attachment means 124 are configured for engagement with a second coupling point 330 of the receiving vessel, the second coupling point 330 located at a position removed from the first coupling point 328 of the receiving vessel 300. In the preferred embodiment, the second coupling point 330 comprises rings arranged to couple to clips of the attachment means 124. The length of the attachment means 124 can then be altered by adjusting the bottle screw 136. In other embodiments, the second coupling point 330 may be any other mechanism suitable for engagement with the attachment means 124.

In the preferred embodiment, the attachment means are secured to the frame 120 at a position removed from the base portion 122 along a first axis. The second coupling point 330 of the receiving vessel 300 is located at a position removed from the first coupling point 328 along a second axis perpendicular to the first axis. This arrangement facilitates an improved anchoring of the transfer manifold 150 on the receiving vessel 300.

The two connection arrangements described above ensure that the transfer manifold 150 has two separate and distinct connection points with the receiving vessel 300. This increases the safety of the operators during the connection of the transfer manifold 150 to the receiving manifold 332 and any subsequent fluid transfer operation. The two points of connection also facilitate easier handling of the flexible hoses 112 by supporting the weight of the transfer manifold 150 and thereby fixing one end of the hoses steady. Furthermore, by supporting the weight of the transfer manifold 150 in two places, the flexible hoses 112 are prevented from being placed under stress or tension, even in rough meteorological conditions or in an emergency disconnection scenario. This is important as placing the hoses under tension may damage the hoses and cause leaks of fuel.

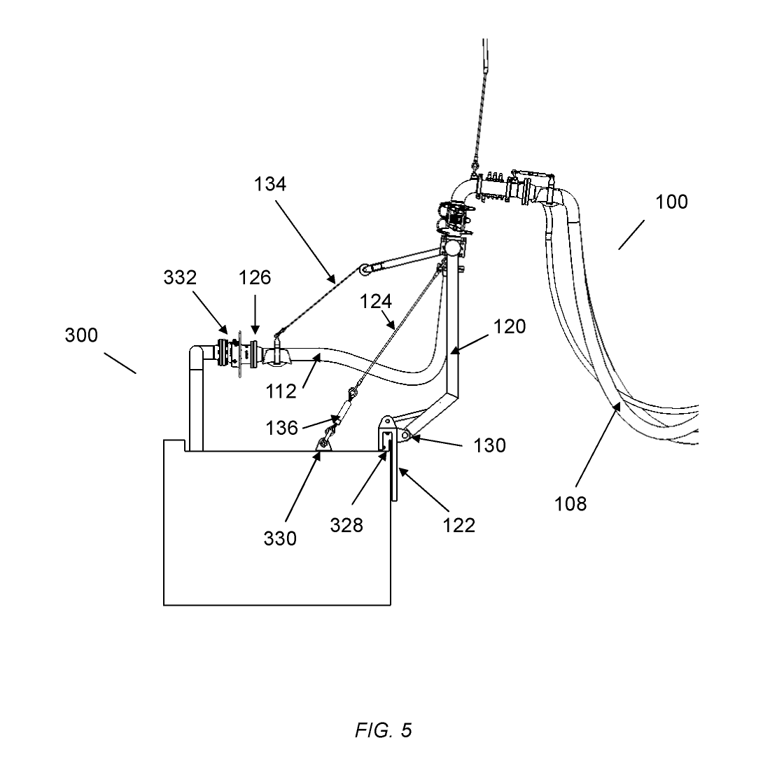

With reference to FIG. 5, the flexible hoses 112 are coupled to support means 134. The support means 134 are extensible and are configured to support the flexible hoses 112 during the manoeuvring of the transfer manifold 150 in order to prevent damage to the connection means 126 or the hoses themselves. Once the manifold 150 is supported on, and attached to, the receiving vessel 300 by the base portion 122 and the attachment means 124 respectively, the longitudinal extent of the support means 134 can be increased in order to lower the flexible hoses 112 towards the receiving manifold. Once the flexible hoses 112 are close enough to the receiving manifold 332 for connection of the transfer manifold 150 to the receiving manifold 332 to occur, the longitudinal extent of the support means 134 can be fixed such that the weight of the flexible hoses 112 is supported. The transfer manifold 150 can then be coupled to the receiving manifold 332 by way of the connection means 126 in order to form a complete fluid path assembly via each flexible hose 112.

Once the transfer manifold 150 is secured to the receiving manifold 332 of the receiving vessel 300, fluid transfer operations can begin. For example, LNG can be transferred to the receiving vessel through one of the catenary hoses 108 while boil-off gas can be received through the other. If the receiving vessel moves during the transfer operation, this movement can be accommodated by flexibility in the fluid transfer apparatus 100. In particular, the catenary hoses 108 provide flexible fluid paths that can accommodate relative movement. Moreover, the movable support arm 102 from which the transfer manifold 150 is suspended allows for relative motion.

As described above, during the transfer of fluid, the member 104 may apply a tensile force to the transfer manifold 150. In some embodiments, the tensile force is constant throughout the transfer operation, although it may be variable in other embodiments. In some embodiments, the member 104 may be a fixed length and may not apply a tensile force to the transfer manifold. As the weight of the transfer manifold 150 is supported by the engagement of the base portion 122 of the rigid frame 120 with the first coupling point 328, and the engagement of the attachment means 124 with the second coupling point, a tensile force through the member 104 is not required to support the transfer manifold during fluid transfer operations. The member 104 is also not required to support the bulk of the weight of the transfer manifold should the transfer manifold 150 become disengaged from the receiving manifold 332 of the receiving vessel, due to the aforementioned multiple connection points of the fluid transfer apparatus 100 with the receiving vessel 300.

However, in an emergency disconnection scenario the member 104 may be required to support the weight of the proximal part of the transfer manifold 150. The emergency disconnection system 114 is configured to disconnect the proximal and distal parts of the transfer manifold 150 should the tension through the emergency disconnection system exceed a predetermined threshold. In an emergency disconnection scenario, in which the emergency disconnection system 114 acts to disconnect the two parts of the transfer manifold, the member 104 can prevent the proximal part of the transfer manifold 150 from dropping into the water.

Accordingly, in the case of an unexpected disengagement, the proximal part of the transfer manifold 150 will move away from the receiving vessel and be supported by the member 104. When the member 104 is under a constant tension, the proximal part of the transfer manifold 150 may preferably be moved upwards away from the receiving vessel 300. Meanwhile, the distal part of the transfer manifold will remain secured to the receiving vessel. This fulfils a safety requirement during fuel transfer. In addition, in the case of an unexpected disengagement, the emergency disconnection system 114 will act to prevent the transfer of fluid through the transfer manifold 150. In particular, the double ball valve of the emergency disconnection system 114 is engaged using power from the hydraulic supply line 116 to close the fluid path through the transfer manifold.

As described above, the transfer manifold 150 comprises two fluid path assemblies which are connected to the receiving manifold 332 through the connection means 126. In other embodiments, the transfer manifold 150 may comprise only one fluid path assembly, or it may comprise more than two fluid path assemblies. As there is currently no standard separation distance for the different fluid path assemblies at the receiving manifold, the use of flexible hoses 112 to form the fluid path through the transfer manifold 150 facilitates the use of the transfer manifold 150 with a range of different widths of receiving manifold 332. Due to the smaller diameter of hose used for fluid transfer of small and medium sized vessels, the flexible hose 112 can be manually moved to the correct position and therefore the separation at the receiving manifold can be adjusted for by making use of the flexibility in the hoses.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may be also provided separately or in any suitable sub-combination.

It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should be noted that the Figures are not necessarily to scale; emphasis instead generally being placed upon illustrating the principles of the present disclosure.

1. A fluid transfer apparatus comprising:
a transfer manifold; and
a frame secured to the transfer manifold, wherein a base portion of the frame is configured for engagement with a first coupling point of a receiving vessel in order to support a weight of the transfer manifold.

2. The apparatus of claim 1, further comprising attachment means secured to the frame at a position removed from the base portion, wherein the attachment means are configured for engagement with a second coupling point of the receiving vessel located at a position removed from the first coupling point.

3. The apparatus of claim 2, wherein the attachment means comprises a cable.

4. The apparatus of claim 2, wherein the attachment means comprises a rigid arm.

5. The apparatus of claim 1, further comprising a support member, wherein the transfer manifold is suspended from the support member.

6. The apparatus of claim 5, wherein the transfer manifold is suspended from the support member by an extensible member.

7. The apparatus of claim 6, wherein the transfer manifold comprises a distal part and a proximal part, the distal part being removably coupled from the proximal part.

8. The apparatus of claim 7, wherein the frame is fixed to the distal part.

9. The apparatus of claim 7, further comprising an emergency disconnection section for coupling the distal part of the transfer manifold to the proximal part, wherein the emergency disconnection section is configured to decouple the distal part from the proximal part when a tension across the transfer manifold exceeds a threshold.

10. The apparatus of claim 7, wherein the distal part of the transfer manifold comprises one or more flexible hoses.

11. The apparatus of claim 10, wherein each of the one or more flexible hoses is configured for connection to a receiving manifold of the receiving vessel.

12. The apparatus of claim 11, wherein support means are coupled between each of the one or more flexible hoses and the distal part of the transfer manifold, and wherein the support means are extensible.

13. The apparatus of claim 12, wherein the support means comprise a winch and a cable.

14. A fluid transfer facility comprising the fluid transfer apparatus of claim 1.

15. A fluid transfer system comprising:
a transfer manifold;
a receiving manifold for coupling to the transfer manifold to form a fluid path therewith;
a first coupling point of a receiving vessel; and
a frame secured to the transfer manifold, wherein a base portion of the frame is configured for engagement with the first coupling point in order to support a weight of the transfer manifold.

16. The system of claim 15, further comprising:
a second coupling point of a receiving vessel, the second coupling point located at a position removed from the first coupling point; and
attachment means secured to the frame at a position removed from the base portion, wherein the attachment means are configured for engagement with the second coupling point.

17. A method for carrying out fluid transfer, comprising:
suspending a transfer manifold from a support member;
manoeuvring the support member until a base portion of a frame secured to the transfer manifold engages with a first coupling point of a receiving vessel;
extending a support means coupled between the transfer manifold and a flexible hose of the transfer manifold to position the flexible hose near to a receiving manifold of the receiving vessel, the flexible hose configured for connection to the receiving manifold;
connecting the flexible hose of the transfer manifold to the receiving manifold; and
initiating a fluid transfer operation between the receiving manifold and the transfer manifold.

18. The method of claim 17, further comprising:
prior to extending, securing attachment means to a second coupling point of the receiving vessel, wherein the attachment means are secured to the frame at a position removed from the base portion, and wherein the second coupling point is located at a position removed from the first coupling point.

19. The method of claim 17, wherein a tensile force is applied to the transfer manifold by an extensible member during the fluid transfer operation.
